(19) United States
(12) Patent Application Publication
(10) Pub. No.: US 2026/0218790 A1
(43) Pub. Date: Jul. 30, 2026

(54) Oil Transfer Device

(71) Applicant: ZF Friedrichshafen AG, Friedrichshafen (DE)

(72) Inventors: Matthias Reisch, Ravensburg (DE); Thomas Kölbl, Ruderting (DE); Heidi Bartlsperger, Ortenburg (DE); Christopher Hödel, Ruderting (DE); Nils Trümper, Holzwickede (DE)

(21) Appl. No.: 19/463,833

(22) Filed: Jan. 29, 2026

(30) Foreign Application Priority Data
Jan. 30, 2025 (DE) 102025103406.0

(51) Int. Cl. F16H 57/04; B60K 17/16; F16H 48/10

(52) U.S. Cl. CPC F16H 57/0483; B60K 17/165; F16H 48/10; F16H 57/0424; F16H 57/043; F16H 57/0456; F16H 57/0471; F16H 2048/104; F16H 2048/106

(57) ABSTRACT

An oil transfer device includes a stationary member and a rotating member, with the rotating member being rotatable relative to the stationary member about a rotational axis. The stationary member defines a main oil channel, with a nozzle being at an end portion of the main oil channel in an oil flow direction, the nozzle defining an opening which forms a nozzle axis. The rotating member includes a wall portion extending in a circumferential direction, with an oil channel being defined in the wall portion, the oil channel extending along an oil channel axis through the wall portion. The nozzle axis and the oil channel axis are configured such that oil from the nozzle flows at least temporarily into the oil channel of the rotating member during a rotation of the rotating member.

### CROSS-REFERENCE TO RELATED APPLICATION

The present application is related and has right of priority to German Patent Application No. 10 2025 103 406.0 filed on Jan. 30, 2025, the entirety of which is incorporated by reference for all purposes.

### FIELD OF THE INVENTION

The present invention relates generally to an oil transfer device, a gearing having an oil transfer device, and a vehicle having a gearing.

### BACKGROUND

Oil guide devices are known which supply oil to various members of a gearing for lubrication and cooling. Particularly in the case of a gearing which has a bearing within a rotating shaft which rotatably supports an internal second rotating shaft, the oil guidance is complicated.

### SUMMARY OF THE INVENTION

It is an object of the present invention to provide an improved oil guide device which enables oil guidance in a simple manner, ensures good oil supply to the members, and keeps friction losses low.

An oil transfer device has a stationary member and a rotating member. The rotating member may extend in an axial direction of the rotating member at least partially within the stationary member. The oil transfer device may be usable for a gearing. The stationary member has a main oil channel, at the end portion of which in the oil flow direction a nozzle is arranged. The main oil channel may be formed by a cylindrical bore. The rotating member is rotatable relative to the stationary member about a rotational axis and has a wall portion extending in a circumferential direction. The rotational axis may be aligned in the axial direction. In the wall portion, an oil channel is provided that extends along an oil channel axis through the wall portion. The nozzle defines an opening which forms a nozzle axis. The nozzle axis and the oil channel axis are configured such that oil from the nozzle flows at least temporarily into the oil channel of the rotating member during a rotation of the rotating member.

An oil flow direction is the direction of the oil in which it moves in the oil transfer device in order to reach the members which are lubricated. In particular, a beginning of an oil channel in the oil flow direction is located upstream of an end of the oil channel.

When oil flows at least temporarily into the oil channel, the oil can emerge from the nozzle in such a way that it does not flow continuously into the oil channel of the rotating member. Rotational angle positions of the rotating member relative to the stationary member may occur for which oil does not flow into the oil channel of the rotating member but flows to the wall portion. The nozzle axis and the oil channel axis may be arranged such that oil from the nozzle can flow alternatingly into the oil channel of the rotating member and onto an outer circumference of the wall portion during a rotation of the rotating member. The oil flow out of the nozzle may be controlled in a stroboscope-like manner via a controller. Thereby, the fraction of oil which flows onto the outer circumference of the wall portion may be reduced or prevented.

The rotating member may define a plurality of oil channels. The number of oil channels may be even. The oil channels may be evenly distributed in the circumferential direction. This enables simplified manufacturing of the rotating member.

Oil which flows onto the outer circumference of the wall portion may serve for the lubrication of components of the gearing. For example, this oil may serve for the lubrication of components which are arranged between the stationary member and the rotating member, such as bearings, e.g. fixed bearings or floating bearings, or sealing elements. The bearings may be configured, for example, as needle bearings or grooved ball bearings. The sealing elements may seal off, for example, an interior space of the gearing toward the outside. One of the sealing elements may be configured, for example, as a radial shaft sealing ring.

The wall portion may be configured to be rotationally symmetrical. The wall portion may extend in the axial direction. The wall portion may be configured to be annular. The wall portion may be configured to be tubular. The wall portion may be configured to be at least partially internally hollow. The wall portion may be configured to be plate-shaped or pot-shaped. The wall portion may be configured to be conical. The wall portion may define a cavity which is configured to be conical. This may have the effect that the oil injected into the rotating member is guided away in the axial direction when it impacts an inner circumferential surface of the cavity.

The cavity in the rotating member may be formed at least partially by a continuous axial bore. The cavity may be sealed to one side in the axial direction by a cover. Thereby, it can be made possible to manufacture a driver toothing on an inner circumference of the rotating member in a cost-effective manner by broaching. Thereby, a good oil tightness to an outer side may be provided in an axially short installation space.

The nozzle axis may be aligned coincidentally with the oil channel axis. The nozzle axis may be aligned substantially perpendicular to the rotational axis. The nozzle axis may intersect the rotational axis. The nozzle axis may be aligned skewed to the rotational axis. The oil channel axis may be aligned parallel to the rotational axis. The nozzle axis may intersect the rotational axis. The nozzle axis may be aligned substantially parallel to the oil channel axis. The oil channel axis may extend in a radial direction of the rotating member. The oil channel axis may be aligned substantially perpendicular to the rotational axis. The oil channel axis may be aligned skewed to the rotational axis. The oil channel axis may be aligned parallel to the rotational axis. The wall portion may then be configured substantially perpendicular to the rotational axis. The nozzle axis may intersect the rotational axis.

The nozzle axis and the oil channel axis may be configured such that the rotating member has a rotational angle position in which the oil channel axis is aligned at least approximately coaxially to the nozzle axis.

The main oil channel may be pressurized. The main oil channel may be supplied with pressurized oil by an oil pump.

In an embodiment, an opening cross section of the nozzle may be smaller than an opening cross section of the oil channel of the rotating member.

The nozzle may define a cylindrical opening. The nozzle may be formed by a cylindrical bore. The nozzle may be a separate member fastened, for example screwed or pressed, to the stationary member. A diameter of the cylindrical bore may be smaller than a diameter of the main oil channel.

The nozzle may be configured such that oil is sprayed out of the nozzle. The nozzle may be configured such that oil leaves the nozzle in the form of a mist. In some instances, the nozzle may be configured such that oil leaves the nozzle in the form of a jet as an oil jet. The nozzle may be configured such that the oil jet has hardly any widening. The diameter of the oil jet may be smaller than the diameter of the oil channel of the rotating member. In some instances, the diameter of the oil jet may be larger than the diameter of the oil channel of the rotating member. The nozzle may be configured such that the oil jet has a speed between 2.5 m/s and 15 m/s. The oil transfer device may be configured such that a lubricating pressure is between 0.05 and 1.5 bar.

A plurality of nozzles may be distributed in the circumferential direction. The nozzles may be unevenly distributed in the circumferential direction. The nozzles may be arranged at least partially offset to each other in the axial direction.

In an embodiment, the oil channel axis may intersect the rotational axis of the rotating member.

In an embodiment, the oil channel axis may define an acute angle with respect to the radial direction of the rotating member. The nozzle axis may define an acute angle with respect to the radial direction of the rotating member. Thereby, components which are arranged in the radial direction within the rotating member and offset to the nozzle in the axial direction may be particularly well supplied with oil in a targeted manner. In addition, oil which is injected through the oil channel of the rotating member may thereby be prevented from emerging again from the rotating member at an oil channel of the rotating member which is opposite with respect to the rotational axis.

In an embodiment, the oil channel axis may be skewed relative to the rotational axis of the rotating member. Thereby, the fraction of the oil reaching the cavity of the rotating member may be increased depending on the direction of rotation.

In an embodiment, the nozzle axis may be skewed relative to the rotational axis of the rotating member. Thereby, the fraction of the oil reaching the cavity of the rotating member may be increased depending on the direction of rotation.

In an embodiment, the rotating member and the stationary member may be arranged such that a gap is formed between the wall region and a region of the stationary member having the nozzle. The gap may be configured to be annular. In some instances, the gap may be configured to be conical. In one instance, the gap may be configured to be tubular. The gap may extend in the axial direction. The gap may extend across a small height. The gap may be configured such that surfaces of the rotating member and the stationary member forming the gap perform the function of a plain bearing. The gap may be configured such that surfaces of the rotating member and the stationary member forming the gap perform the function of a gap seal.

In an embodiment, the oil channel of the rotating member may be formed as an elongated hole in the circumferential direction. The elongated hole may be formed radially symmetrically to the rotational axis. For example, the elongated hole may be formed by pivoting a milling cutter, the rotational axis of which intersects the rotational axis. The elongated hole may be formed perpendicular to the rotational axis. For example, the elongated hole may be formed by moving a milling cutter away from the rotational axis without changing its orientation in the process. Thereby, when the rotating member is rotating slowly, a large amount of oil can be injected into the cavity of the rotating member through the oil channel of the rotating member.

In an embodiment, the rotating member may define an odd number of oil channels. Thereby, when the rotating member is stationary or rotating slowly, oil which is injected through one of the oil channels can be prevented from emerging again at an oil channel which is opposite with respect to the rotational axis.

In an embodiment, the rotating member may define a number of oil channels which are unevenly distributed in the circumferential direction. The rotating member may define an even number of oil channels. The oil channels may then be arranged such that they are not arranged opposite to each other with respect to the rotational axis. A lubricating pressure and thus a flow velocity of the oil may be adaptable depending on the rotational speed of the rotating member such that oil which is injected through one of the oil channels does not emerge at an oil channel which is opposite with respect to the rotational axis. The lubricating pressure may be adjustable, for example, via a rotational speed of the oil pump.

In an embodiment, the oil transfer device may be usable for a gearing. The gearing may include an input element, a first output shaft, a second output shaft, a bearing for the first planetary carrier, a first bearing for the second output shaft, a second bearing for the second output shaft, a first gear set, and a second gear set. The stationary member may further form an oil channel for the first gear set and an oil channel for the second gear set, which are in fluid communication with the main oil channel. The main oil channel may extend in the axial direction in a region in which the first gear set and the second gear set are arranged. The bearing for the first planetary carrier may be in fluid communication with the oil channel of the rotating member. The oil which is injected through the oil channel of the rotating member may serve for the lubrication of the bearing for the first planetary carrier. The first bearing for the second output shaft and the second bearing for the second output shaft may be in fluid communication with the nozzle of the main oil channel. The oil which is injected onto the wall portion of the rotating member may serve for the lubrication of the first bearing for the second output shaft and of the second bearing for the second output shaft.

If two elements are in fluid communication with one another, a fluid, for example oil, may be guided from the one element to the other element. In this case, the fluid connection may be configured to be leakage-free such that the oil is guided substantially completely from the one element to the other element.

The oil which is injected through the oil channel of the rotating member may serve for at least one of the lubrication or the cooling of components of the gearing. The components of the gearing may include a bearing, for example a radial or axial plain bearing, a radial or axial rolling bearing, a driver toothing, a running toothing, for example a planetary toothing, a bevel gear toothing or a spur gear toothing, or a combination thereof. The oil which is injected through the oil channel of the rotating member may, for example, lubricate a driver toothing via which one of the elements of the first or of the second gear set is non-rotatably connected to one of the first output shaft and the second output shaft.

The nozzle in the stationary member may serve for the distribution of volume flows of the oil in the oil transfer device. For this purpose, the nozzle may act as an oil throttle, for example an oil orifice. An oil throttle, for example an oil orifice, may be provided in at least one of the oil channel for the first gear set and the oil channel for the second gear set. A plurality of oil throttles, for example oil orifices, may be provided in parallel in the main oil channel, the oil channel for the first gear set, and the oil channel for the second gear set. Thereby, oil flows to the individual lubrication or cooling locations may be adjusted as required.

In an embodiment, the first gear set may include a first pin which defines a cavity and a recess which extends in the radial direction from the cavity through the first pin to an outer side of the first pin. A capturing member having a capturing surface may be arranged so as to capture oil from one end of the oil channel for the first gear set in the radial direction and to guide it to the first pin in the axial direction.

In an embodiment, the main oil channel may include an annular channel, which extends annularly in the circumferential direction and which is in fluid communication with the oil channel for the first gear set and with the oil channel for the second gear set.

In an embodiment, the oil guide arrangement has a carrier element which is non-rotatably connected to the stationary member. The carrier element may extend in the circumferential direction. The carrier element may cover the annular channel. The carrier element may cover the annular channel in an axial direction. The carrier element may seal off the annular channel. The carrier element may form the annular channel at least partially. The carrier element may receive a second pin.

In an embodiment, the second gear set may have a second pin which defines a cavity and a recess that extends in the radial direction from the cavity through the second pin to an outer side of the second pin. The cavity may be in fluid communication with the annular channel. The second pin may be attached to the carrier element. An oil throttle, for example an oil orifice, may be provided in the cavity of the second pin.

In one aspect, a gearing has an input element, a first output shaft, a second output shaft, a first gear set, a second gear set, and an oil transfer device according to one of the preceding embodiments. The first gear set and the second gear set are mechanically operatively connected to one another in such a manner that a torque may be transmitted from the first gear set to the second gear set. The first output shaft is configured to output a torque from the first gear set. The second output shaft is configured to output a torque from the second gear set. The second output shaft forms the rotating member of the oil transfer device. The gearing may perform the function of a differential.

In an embodiment, the first gear set may be formed by a first planetary gear set and the second gear set may be formed by a second planetary gear set. The input element may be non-rotatably connected to a first sun gear of the first planetary gear set. A first planetary carrier of the first planetary gear set may be non-rotatably connected to the first output shaft for outputting a torque from the first planetary gear set. A second ring gear of the second planetary gear set may be non-rotatably connected to the second output shaft for outputting a torque from the second planetary gear set.

The first planetary gear set may include the first sun gear, the first planetary carrier, a first planetary pin, a first planetary gear, and a first ring gear. One of the first planetary pins may form the first pin. The first sun gear may be engaged with the first planetary gear. The first planetary gear may be engaged with the first ring gear. The first planetary gear may be rotatably supported on the first planetary pin. The first planetary pin may be attached to the first planetary carrier.

The second planetary gear set may include a second sun gear, a second planetary carrier, a second planetary pin, a second planetary gear, and the second ring gear. One of the second planetary pins may form the second pin. The second sun gear may be engaged with the second planetary gear. The second planetary gear may be engaged with the second ring gear. The second planetary gear may be rotatably supported on the second planetary pin. The second planetary pin may be attached to the second planetary carrier.

The input element may form the first sun gear on an outer circumference. The first ring gear may be non-rotatably connected to the second sun gear. A sun-ring-gear may form the first ring gear on an inner circumference and the second sun gear on an outer circumference. The second planetary carrier may be non-rotatably connected to a stationary member. The stationary member may be formed by a gearing housing.

In some instances, the first planetary gear set and the second planetary gear set may be arranged in the same plane in the axial direction. The second planetary gear set may be arranged outside the first planetary gear set in the radial direction. In some instances, the first planetary gear set and the second planetary gear set may be arranged offset to each other in the axial direction.

The oil which is injected through the oil channel of the rotating member may lubricate a driver toothing via which the first planetary carrier is non-rotatably connected to the first output shaft. For oil supply to the driver toothing, the embodiment of the oil guide device is usable in which at least one of the oil channel axis and the nozzle axis defines an acute angle with respect to the radial direction of the rotating member. Particularly when the part of the driver toothing which is located outside in the radial direction and which is formed by the first planetary carrier protrudes towards the nozzle in the axial direction, the oil may be effectively supplied to the driver toothing. Oil may be transported through the driver toothing to a cooling location adjacent in the axial direction, for example a region in which the first sun gear is arranged.

In an embodiment, the gearing may further include a bearing for the first planetary carrier, a first bearing for the second output shaft, and a second bearing for the second output shaft. The support of the second output shaft may be configured by one, two, or more bearings. A bearing may be configured as a plain bearing, a rolling bearing, an axial bearing, or a radial bearing.

In a further aspect, a vehicle has a driving unit, at least two driving wheels, and a gearing according to any one of the preceding embodiments and aspects. The driving unit is configured to drive the input element. One of the driving wheels is configured to drive the vehicle via the first output shaft. The other of the driving wheels is configured to drive the vehicle via the second output shaft.

### BRIEF DESCRIPTION OF THE DRAWINGS

FIG. 1 shows a sectional view of an embodiment of a gearing having an oil transfer device.

FIG. 2 shows a sectional view of an embodiment of the oil transfer device.

FIG. 3 shows a sectional view of a further embodiment of the oil transfer device.

FIG. 4 shows a sectional view of a further embodiment of the oil transfer device.

FIG. 5 shows a sectional view of a further embodiment of the oil transfer device.

FIG. 6 shows a sectional view of a further embodiment of the oil transfer device.

FIG. 7 shows a sectional view of a further embodiment of the oil transfer device.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

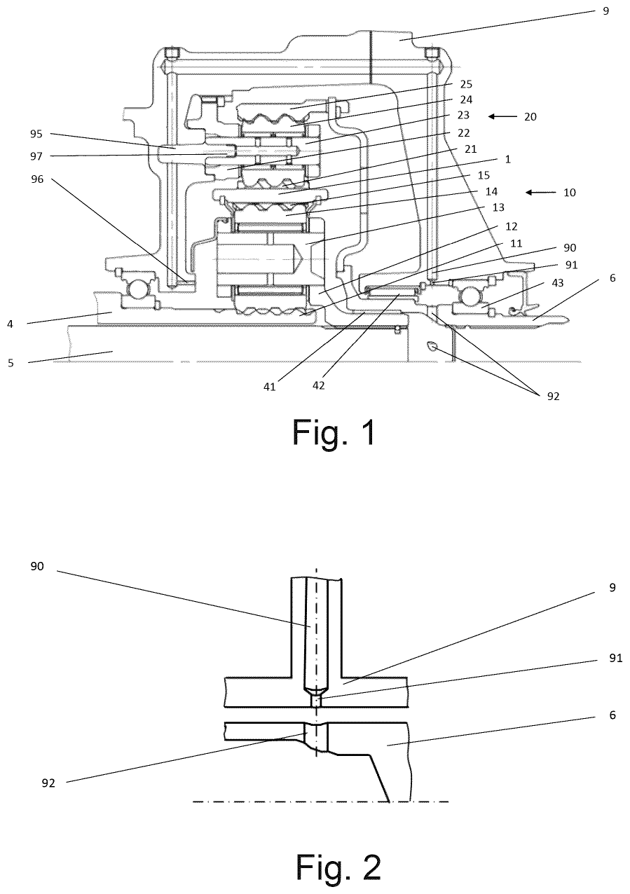

FIG. 1 shows a sectional view of an embodiment of a gearing having an oil transfer device. The gearing has an input element 4, a first output shaft 5, a second output shaft 6, a first gear set, in the present case a first planetary gear set 10, a second gear set, in the present case a second planetary gear set 20, and the oil transfer device. The oil transfer device has a stationary member 9, in the present case a gearing housing, and a rotating member formed by the second output shaft 6 and rotating relative to the stationary member 9.

The stationary member 9 defines a main oil channel 90, at the end portion of which in the oil flow direction a nozzle 91 is arranged. The nozzle 91 defines an opening which forms a nozzle axis. The second output shaft 6 has a wall portion extending in a circumferential direction. In the wall portion, a number of oil channels 92 is provided, where each oil channel 92 extends along an oil channel axis through the wall portion. The nozzle axis and the oil channel axes are configured such that oil from the nozzle 91 flows at least temporarily into one of the oil channels 92 of the second output shaft 6 in a radial direction of the second output shaft 6 inwardly into a cavity of the second output shaft 6 during a rotation of the second output shaft 6.

### In the following, further details of the gearing and the oil transfer device will be described.

The first planetary gear set 10 has a first sun gear 11, a first planetary carrier 12, a number of first planetary pins 13, a number of first planetary gears 14, and a first ring gear 15. The first sun gear 11 is engaged with one of the first planetary gears 14. One of the first planetary gears 14 is engaged with the first ring gear 15 and rotatably supported on one of the first planetary pins 13. The first planetary pins 13 are attached to the first planetary carrier 12.

The second planetary gear set 20 has a second sun gear 21, a second planetary carrier 22, a number of second planetary pins 23, a number of second planetary gears 24, and a second ring gear 25. The second sun gear 21 is engaged with one of the second planetary gears 24. One of the second planetary gears 24 is engaged with the second ring gear 25 and rotatably supported on one of the second planetary pins 23. The second planetary pins 23 are attached to the second planetary carrier 22.

The first planetary gear set 10 and the second planetary gear set 20 are arranged in the same plane in an axial direction. The second planetary gear set 20 is arranged outside the first planetary gear set 10 in the radial direction.

The input element 4 forms the first sun gear 11 of the first planetary gear set 10 on an outer circumference of an end portion of the input element 4 on one side of the first output shaft 5 in the axial direction. The first planetary carrier 12 is non-rotatably connected to the first output shaft 5 for outputting a torque from the first planetary gear set 10. The second planetary carrier 22 is non-rotatably connected to the stationary member 9. The second ring gear 25 is non-rotatably connected to the second output shaft 6 for outputting a torque from the second planetary gear set 20.

The first ring gear 15 and the second sun gear 21 are formed by a sun-ring-gear 1. The sun-ring-gear 1 has the first ring gear 15 on an inner circumference. The sun-ring-gear 1 has the second sun gear 21 on an outer circumference. Thereby, the first planetary gear set 10 is mechanically operatively connected to the second planetary gear set 20.

The first output shaft 5 and the second output shaft 6 are arranged coaxially to the input element 4. The first output shaft 5 extends in the axial direction through the input element 4. The first output shaft 5 extends in the axial direction partially within the second output shaft 6. The first planetary carrier 12 is rotatably supported in the second output shaft 6 via a bearing 41. The bearing 41 for the first planetary carrier 12 is configured as a plain bearing. The first output shaft 5 and the second output shaft 6 extend in the axial direction in opposite directions. The second output shaft 6 is rotatably supported in the stationary member 9 via a first bearing 42 and a second bearing 43. The first bearing 42 for the second output shaft 6 is configured as a needle bearing. The second bearing 43 for the second output shaft 6 is configured as a grooved ball bearing.

The nozzle 91 and the oil channels 92 of the second output shaft 6 are arranged in the axial direction between the first bearing 42 for the second output shaft 6 and the second bearing 43 for the second output shaft 6. The nozzle 91 is configured as a cylindrical bore at one end in the oil flow direction of the main oil channel 90. The oil channels 92 of the second output shaft 6 are configured as cylindrical bores. The opening cross section of the nozzle 91 is smaller than an opening cross section of one of the oil channels 92 of the second output shaft 6. The nozzle axis and the oil channel axes are aligned perpendicular to a rotational axis of the second output shaft 6. The nozzle axis and the oil channel axes intersect the rotational axis. The oil channels 92 are unevenly distributed in the circumferential direction.

During the rotation of the second output shaft 6, the angular positions of the oil channel axes with respect to the nozzle axis change in the circumferential direction. With a suitable rotational angle position of the second output shaft 6, one of the oil channel axes is coincident with the nozzle axis. The nozzle 91 and the oil channels 92 of the second output shaft 6 are configured such that, for specific rotational angle positions of the second output shaft 6, oil is sprayed from the nozzle 91 through one of the oil channels 92 of the second output shaft 6 into the cavity of the second output shaft 6. In the remaining rotational angle positions, oil is injected onto an outer circumference of the wall portion. The nozzle 91 and the oil channels 92 of the second output shaft 6 are configured such that oil from the nozzle 91 is injected alternatingly into one of the oil channels 92 of the second output shaft 6 and onto the outer circumference of the wall portion during a rotation of the rotating member.

The second output shaft 6 and the stationary member 9 are arranged such that an annular gap is formed between the wall region of the second output shaft 6 and a region of the stationary member 9 having the nozzle 91. An inner circumference of the wall portion is configured to be conical and tapering towards the right-hand side in FIG. 1. Thereby, oil which is injected through one of the oil channels 92 of the second output shaft 6 is conveyed to the left in the axial direction as soon as it reaches the inner circumference of the wall portion. Thereby, oil which is injected through one of the oil channels 92 of the second output shaft 6 is prevented from emerging again outwardly in the radial direction through one of the oil channels 92 of the second output shaft 6.

The first bearing 42 for the second output shaft 6 and the second bearing 43 for the second output shaft 6 are supplied with oil within the annular gap, which oil is injected onto the outer circumference of the wall portion. In this respect, the first bearing 42 for the second output shaft 6 and the second bearing 43 for the second output shaft 6 are in fluid communication with the nozzle 91 of the main oil channel 90. The oil which flows away through the bearing 41 for the first planetary carrier 12 in this case also cools the second output shaft 6 which is heated by a heat input of the bearing 41 for the first planetary carrier 12. The oil which flows away via the second bearing 43 for the second output shaft 6 also lubricates a radial shaft sealing ring arranged on the right-hand side of the second bearing 43 for the second output shaft 6. Between the second bearing 43 for the second output shaft 6 and the radial shaft sealing ring, a relief channel (not shown) is provided. Oil can flow away in a pressure-free manner via the relief channel.

The bearing 41 for the first planetary carrier 12 is in fluid communication with the oil channel(s) 92 of the second output shaft 6 via the cavity in the second output shaft 6. The oil channel(s) 92 of the second output shaft 6 opens into the cavity of the second output shaft 6. The cavity of the second output shaft 6 is closed in an oil-tight manner towards the right-hand side in FIG. 1 by a pressed-in sheet metal cover. The oil is thus guided to the bearing 41 for the first planetary carrier 12.

The stationary member 9 further forms an oil channel 96 for the first planetary gear set 10 and an oil channel 97 for the second planetary gear set 20, which are in fluid communication with the main oil channel 90. The main oil channel 90 extends in a vertical direction on the right-hand side of the first planetary gear set 10 and the second planetary gear set 20 in FIG. 1. At an upper end region of the main oil channel 90 in the vertical direction, the main oil channel 90 extends in a horizontal direction to a left-hand side of the first planetary gear set 10 and the second planetary gear set 20. On the left-hand side, the main oil channel 90 extends in the vertical direction downwards to the annular channel 95, which is in fluid communication with the oil channel 97 extending in the axial direction for the second planetary gear set 20, and the oil channel 96 for the first planetary gear set 10. The main oil channel 90 is configured as a cylindrical bore.

The annular channel 95 extends in the circumferential direction. The annular channel 95 is covered in the axial direction on the right-hand side in FIG. 1 by the second planetary carrier 22.

The second planetary pins 23 each define a cavity extending in the axial direction and a number of recesses that extend in the radial direction from the cavity through the second planetary pin 23 to an outer side of the second planetary pin 23. The recesses lubricate a bearing for one of the second planetary gears 24. The cavity of the second planetary pin 23 is in fluid communication with the annular channel 95. An oil orifice is provided in the cavity of the second planetary pin 23.

The oil channel 96 for the first planetary gear set 10 extends in the axial direction from the main oil channel 90 towards the first planetary gear set 10. The oil channel 96 for the first planetary gear set 10 is configured as a cylindrical bore which has a smaller diameter than the main oil channel 90. The oil channel 96 for the first planetary gear set 10 forms an oil orifice.

The first planetary pins 13 each define a cavity extending in the axial direction and a number of recesses. Each of the recesses extends in the radial direction from the cavity through the first planetary pin 13 to an outer side of the first planetary pin 13. A bearing for one of the first planetary gears 14 is respectively lubricated via the recesses of one of the first planetary pins 13. A capturing member having a capturing surface is arranged so as to capture oil in the radial direction from an end portion of the oil channel 96 for the first planetary gear set 10 and to guide it to the first planetary pin 13 in the axial direction.

The main oil channel 90 is supplied with pressurized oil by an oil pump (not shown). The nozzle 91 forms an oil orifice. With the nozzle 91, the oil channel 96 for the first planetary gear set 10, and the oil orifice in the oil channel 97 for the second planetary gear set 20, a distribution of volume flows of the oil in the gearing is adjusted.

The fraction of the oil which reaches the cavity of the second output shaft 6 through the oil channels 92 of the second output shaft 6 decreases with increasing rotational speed of the second output shaft 6. The bearing 41 for the first planetary carrier 12 requires oil supply only at different or differential wheel rotational speeds and different or differential rotational speeds of the first output shaft 5 and the second output shaft 6, i.e. in particular when the vehicle is driving around a bend. In this respect, the bearing 41 for the first planetary carrier 12 requires low oil supply, in particular at high driving speeds of the vehicle. Therefore, at high driving speeds, more oil is available for other components, such as the first bearing 42 for the second output shaft 6 and the second bearing 43 for the second output shaft 6.

FIG. 2 shows a detail, sectional view of an embodiment of the oil transfer device. In the present embodiment, the oil transfer device has the stationary member 9 with the main oil channel 90 extending in the vertical direction, which at one end in the oil flow direction has the nozzle 91 described in the preceding embodiment. Furthermore, the oil transfer device in the present embodiment has the second output shaft 6 with the oil channels 92 as described in the preceding embodiment.

In the nozzle 91, the oil is accelerated to form an oil jet. With a suitable rotational angle position of the second output shaft 6 relative to the stationary member 9, the oil jet is sprayed through the wall portion of the second output shaft 6 via the oil channel 92 of the second output shaft 6.

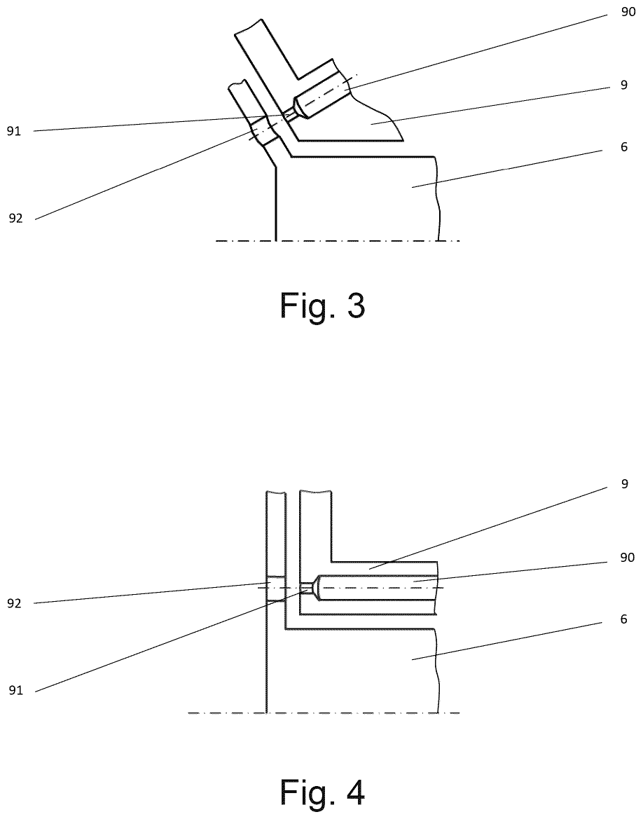

FIG. 3 shows a sectional view of a further embodiment of the oil transfer device. The present embodiment differs from the preceding embodiment in that the oil channel axes of the oil channels 92 and the nozzle axis of the nozzle 91 each define an acute angle with respect to the radial direction. The oil channel axes and the nozzle axis are arranged tilted in the axial direction from the orientation perpendicular to the rotational axis. In this respect, the oil jet also defines an acute angle with respect to the radial direction. The wall portion of the second output shaft 6 is configured to be conical.

By this direction of the oil jet, components which are located further inwardly in the radial direction and arranged offset to the nozzle 91 in the axial direction may be particularly well supplied with oil in a targeted manner. An example of this is a driver toothing arranged between the first planetary carrier 12 and the first output shaft 5, as shown in FIG. 1. Particularly when the first planetary carrier 12 located outside in the radial direction protrudes in the axial direction beyond an end portion of the first output shaft 5 towards the nozzle 91, the oil can be effectively guided to the driver toothing. In a further embodiment, oil may be transported in the axial direction through the driver toothing to a cooling location, for example a region of the first sun gear 11.

FIG. 4 shows a sectional view of a further embodiment of the oil transfer device. The present embodiment differs from the preceding embodiment in that the oil channel axes and the nozzle axis are each aligned in the axial direction. The wall portion extends in the radial direction.

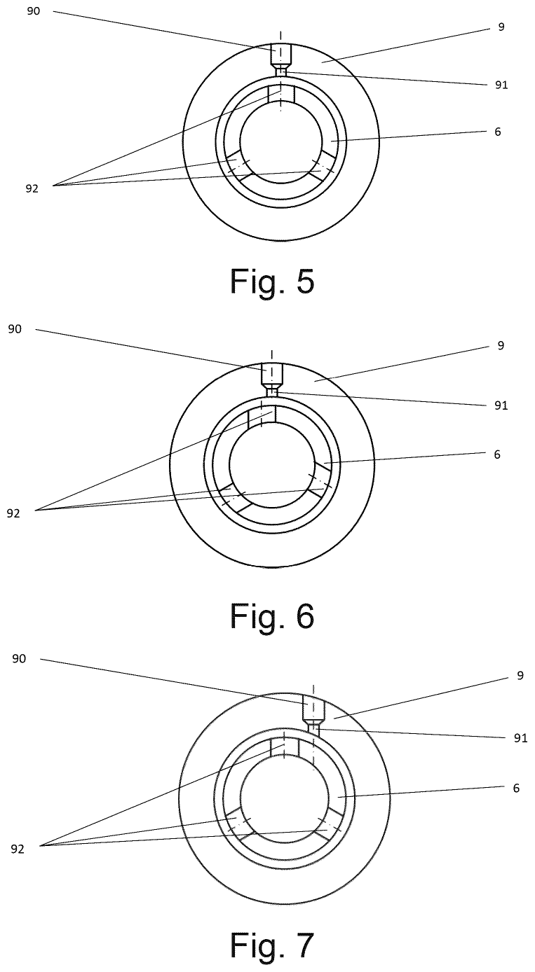

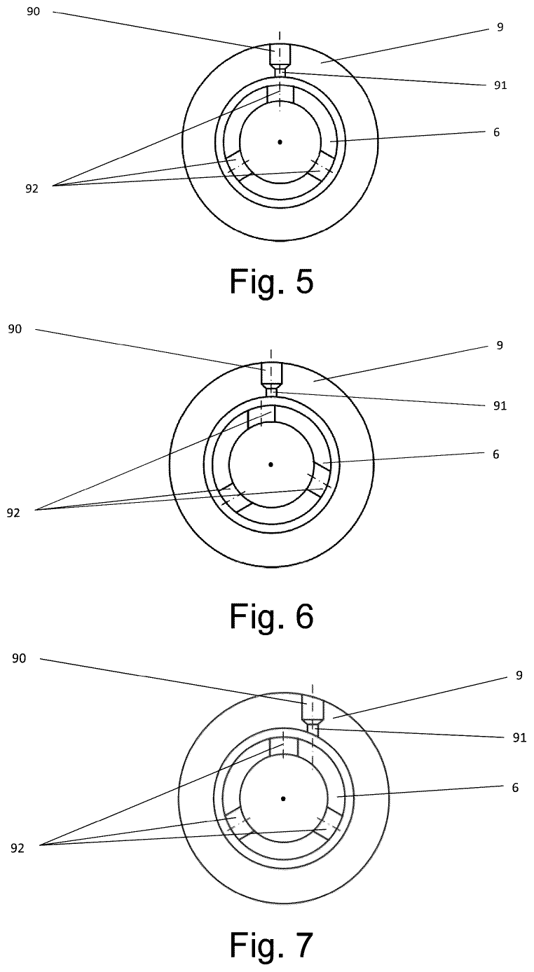

FIG. 5 shows a sectional view of a further embodiment of the oil transfer device. In FIG. 5, the oil guide arrangement described with respect to FIG. 2 is shown in or viewed along the axial direction. The present embodiment includes all the features of the embodiment described with respect to FIG. 2. The oil channel axes and the nozzle axis each intersect the rotational axis.

FIG. 6 shows a sectional view of a further embodiment of the oil transfer device. The present embodiment differs from the embodiment described with respect to FIG. 5 in that the oil channel axes of the oil channels 92 are arranged offset with respect to the rotational axis. In an alternative embodiment, the oil channel axes are skewed to the rotational axis.

FIG. 7 shows a sectional view of a further embodiment of the oil transfer device. The present embodiment differs from the embodiment described with respect to FIG. 5 in that the nozzle axis is arranged offset with respect to the rotational axis. In an alternative embodiment, the nozzle axis is skewed to the rotational axis.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 sun-ring-gear
4 input element
5 first output shaft
6 second output shaft
9 stationary member
10 first planetary gear set
11 first sun gear
12 first planetary carrier
13 first planetary pin
14 first planetary gear
15 first ring gear
20 second planetary gear set
21 second sun gear
22 second planetary carrier
23 second planetary pin
24 second planetary gear
25 second ring gear
41 bearing for the first planetary carrier
42 first bearing for the second output shaft
43 second bearing for the second output shaft
90 main oil channel
91 nozzle of the main oil channel
92 oil channel of the second output shaft or of the rotating member
95 annular channel
96 oil channel for the first gear set
97 oil channel for the second gear set

1-19. (canceled)

20. An oil transfer device, comprising:
a stationary member (9) defining a main oil channel (90), a nozzle (91) being at an end portion of the main oil channel (90) in an oil flow direction, the nozzle (91) defining an opening which forms a nozzle axis; and
a rotating member, the rotating member being rotatable relative to the stationary member (9) about a rotational axis, the rotating member comprising a wall portion extending in a circumferential direction, an oil channel (92) being defined in the wall portion, the oil channel (92) extending along an oil channel axis through the wall portion,
wherein the nozzle axis and the oil channel axis are configured such that oil from the nozzle (91) flows at least temporarily into the oil channel (92) of the rotating member during a rotation of the rotating member.

21. The oil transfer device of claim 20, wherein an opening cross section of the nozzle (91) is smaller than an opening cross section of the oil channel (92) of the rotating member.

22. The oil transfer device of claim 20, wherein the oil channel axis intersects the rotational axis of the rotating member.

23. The oil transfer device of claim 20, wherein the oil channel axis is at an acute angle with respect to a radial direction of the rotating member.

24. The oil transfer device of claim 20, wherein the oil channel axis is skewed relative to the rotational axis of the rotating member.

25. The oil transfer device of claim 20, wherein the nozzle axis is skewed relative to the rotational axis of the rotating member.

26. The oil transfer device a of claim 20, wherein a gap is defined between the wall portion of the rotating member and a region of the stationary member (9) comprising the nozzle (91).

27. The oil transfer device a of claim 20, wherein the oil channel (92) of the rotating member is formed by an elongated hole in the circumferential direction.

28. The oil transfer device of claim 20, wherein the oil channel (92) is one of an odd number of oil channels (92) defined in the rotating member.

29. The oil transfer device of claim 20, wherein the oil channel (92) is one of a plurality of oil channels (92) defined in the rotating member, the plurality of oil channels (92) being unevenly distributed in the circumferential direction.

30. The oil transfer device of claim 20, wherein:
the oil transfer device is usable with a gearing comprising an input element (4), a first output shaft (5), a second output shaft (6), a bearing (41) for a first planetary carrier (12), a first bearing (42) for the second output shaft (6), a second bearing (43) for the second output shaft (6), a first gear set, and a second gear set,
the stationary member (9) further forms a first oil channel (96) for the first gear set and a second oil channel (97) for the second gear set, the first and second oil channels (96, 97) being in fluid communication with the main oil channel (90),
the bearing (41) for the first planetary carrier (12) is in fluid communication with the oil channel (92) of the rotating member, and
the first bearing (42) for the second output shaft (6) and the second bearing (43) for the second output shaft (6) are in fluid communication with the nozzle (91) of the main oil channel (90).

31. The oil transfer device of claim 30, wherein:
the first gear set comprises a first pin which comprises a cavity and a recess which extends in a radial direction from the cavity through the first pin to an outer side of the first pin, and
a capturing member having a capturing surface is arranged for catching oil from the first oil channel for the first gear set in the radial direction and to guiding the oil caught to the first pin in an axial direction.

32. The oil transfer device of claim 30, wherein the main oil channel (90) defines an annular channel (95), the annular channel (95) extends annularly in the circumferential direction and is in fluid communication with the first oil channel (96) for the first gear set and the second oil channel (97) for the second gear set.

33. The oil transfer device of claim 32, further comprising a carrier element, the carrier element being non-rotatably connected to the stationary member (9), the carrier element extending in the circumferential direction, and the carrier element covering the annular channel (95).

34. The oil transfer device of claim 32, wherein the second gear set comprises a second pin which defines a cavity and a recess that extends in a radial direction from the cavity through the second pin to an outer side of the second pin, the cavity being in fluid communication with the annular channel (95).

35. A gearing, comprising:
an input element (4);
a first output shaft (5);
a second output shaft (6);
a first gear set;
a second gear set; and
the oil transfer device of claim 20,
wherein the first gear set and the second gear set are mechanically operatively connected to one another such that a torque transmittable from the first gear set to the second gear set,
wherein the first output shaft (5) is configured to output a torque from the first gear set, and
wherein the second output shaft (6) is configured to output a torque from the second gear set, the rotating member of the oil transfer device comprising the second output shaft (6).

36. The gearing of claim 35, wherein:
the first gear set comprises a first planetary gear set (10) and the second gear set comprises a second planetary gear set (20),
the input element (4) is non-rotatably connected to a first sun gear (11) of the first planetary gear set (10),
a first planetary carrier (12) of the first planetary gear set (10) is non-rotatably connected to the first output shaft (5) for outputting the torque from the first planetary gear set (10), and
a second ring gear (25) of the second planetary gear set (20) is non-rotatably connected to the second output shaft (6) for outputting the torque from the second planetary gear set (20).

37. The gearing of claim 36, further comprising:
a bearing (41) for the first planetary carrier (12);
a first bearing (42) for the second output shaft (6); and
a second bearing (43) for the second output shaft (6).

38. A vehicle, comprising:
a driving unit;
at least two driving wheels; and
the gearing of claim 35,
wherein the driving unit is configured to drive the input element (4),
wherein the first output shaft (5) is configured to drive one of the at least two driving wheels, and
wherein the second output shaft (6) is configured to drive another of the at least two driving wheels.
